(19) United States
(12) Patent Application Publication
(10) Pub. No.: US 2008/0224441 A1
(43) Pub. Date: Sep. 18, 2008

(54) Foldable bicycle

(76) Inventor: I-Shyong Lu, Taichung City (TW)

Correspondence Address: CHARLES E. BAXLEY, ESQUIRE, 90 JOHN STREET, SUITE 309, NEW YORK, NY, 10038, US

(21) Appl. No.: 11/716,855

(22) Filed: Mar. 12, 2007

(51) Int. Cl. B62K 3/02

(52) U.S. Cl. 280/278

(57) ABSTRACT

A foldable bicycle that comprises a folding segment provided on the frame thereof, whereupon the bicycle can be folded in the manner that a front wheel is settled at the side of a back wheel of the bicycle. The bicycle further comprise an auxiliary wheel deposited on the frame in front of the folding segment so that when the bicycle is folded, the auxiliary wheel, the front wheel and back wheel of the bicycle can function as three supporting points that are arranged in a triangular form on a plane.

### BACKGROUND OF THE INVENTION

1. Technical Field

The present invention relates to a foldable bicycle that can be folded in either a clockwise or anti-clockwise direction. The disclosed foldable bicycle is particularly characterized by having an auxiliary wheel. Since when the bicycle is folded, the front and back wheels are positioned almost abreast; the auxiliary wheel can work in concert with the front and back wheels to support the folded bicycle with supporting points that are arranged in a triangular form on the ground. Thereby, the folded bicycle can stand stably or move steady under an external push or pull force.

2. Description of Related Art

A conventional art related to a folded bicycle principally implements a folding segment provided on the frame of the bicycle whereupon the front portion can be folded toward the back portion of the bicycle and the front and back wheels of the bicycle can be settled abreast to achieve the objective of reducing the amount of floor space taken by the bicycle and facilitating portability of the bicycle.

However, one problem with such a strategy is that when being folded, such conventional foldable bicycle typically stands on the chainwheel protector as a third supporting point in addition to the front and back wheels. This may consequently cause damage or deformation to the chainwheel protector. Also, the portability and mobility of the folded bicycle have never been perfect in practice.

To remedy foresaid problem, another conventional foldable bicycle is provided. This conventional foldable bicycle has a seat stem that can be plunged downward through the frame and stretching out from the bottom of a seat tube so that the seat stem can function as a third supporting point to support the folded bicycle in concert with the front and back wheels. Nevertheless, friction between the bottom of the seat stem and the ground can substantially cause a drag upon pushing or pulling the folded bicycle.

### SUMMARY OF THE INVENTION

It is one objective of the present invention to provide a foldable bicycle having at least one auxiliary wheel provided at the left side, right side or bottom of the fame that can be shifted up or down so as to provide at a third supporting point to the folded bicycle. When the bicycle is folded and carries a basket or rack, the auxiliary wheel can be landed or retracted optionally due to user's need. As the auxiliary wheel is landed, the folded bicycle can work as a tri-wheel hand wagon or pull cart; while as the auxiliary wheel is retracted, the folded bicycle can work as a dual-wheel hand wagon or pull cart.

It is another objective of the present invention to provide a foldable bicycle having an auxiliary wheel that substitutes the chainwheel protector and folding segment to be a third supporting point of the folded bicycle. Thus, the chainwheel protector and folding segment can be prevented against attrition and the folded bicycle can be stably supported. As a result, the disclosed foldable bicycle can be easily operated, moved or carried by even a child or girl. Meantime, the disclosed foldable bicycle is a multi-functioned wheel cart facilitating conveying heavy articles.

To achieve these and other objectives, the present invention involves equipping an auxiliary wheel to a foldable bicycle that can be folded in either a clockwise or anti-clockwise direction. When the bicycle is folded, the front and back wheels are settled almost abreast and the auxiliary wheel can work in concert with the front and back wheels to support the folded bicycle with supporting points that are arranged in a triangular form on the ground.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of a rack of the disclosed foldable bicycle;

FIG. 2 is a perspective view of the disclosed foldable bicycle showing it expanded;

FIG. 3 is a perspective view of the disclosed foldable bicycle showing it folded;

FIG. 4 is a lateral view of the disclosed foldable bicycle showing the rack being equipped thereto;

FIG. 5 is a lateral view of the disclosed foldable bicycle;

FIG. 6 is an exploded view of the auxiliary wheel of the present invention;

FIG. 7 is an applied view of the disclosed foldable bicycle showing the rack being appended onto the tail thereof; and

FIG. 8 is an applied view of the disclosed foldable bicycle showing a basket being appended onto, the tail thereof; and

### DETAILED DESCRIPTION OF THE PREFERRED EMBODIMENT

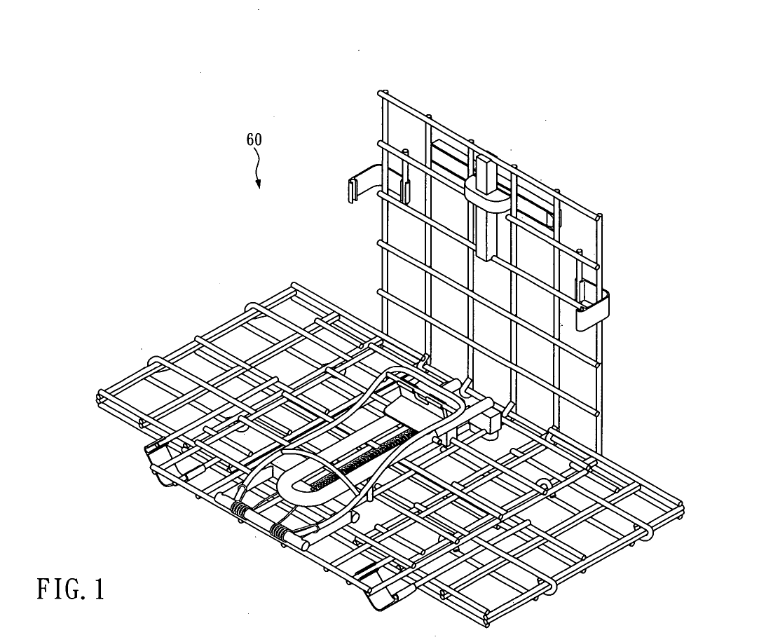

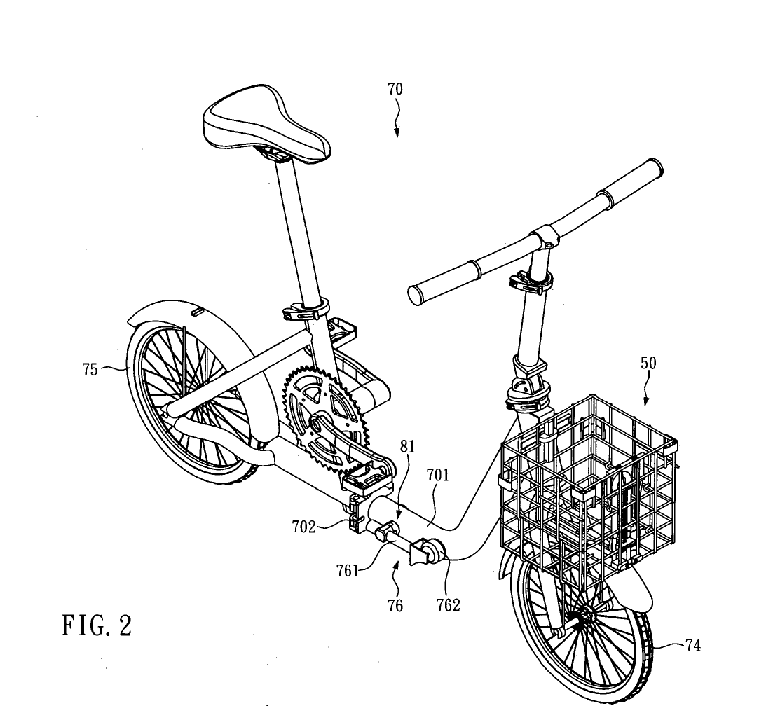

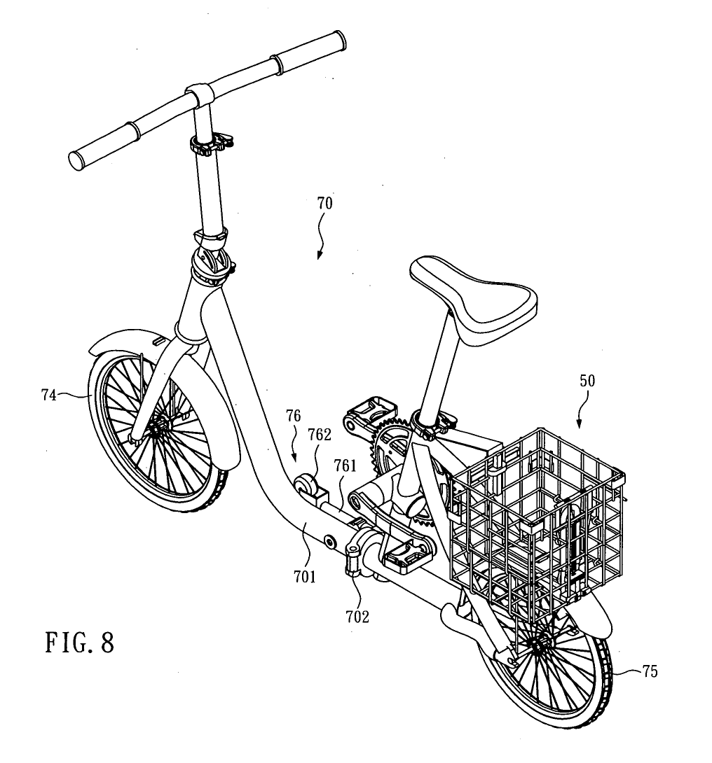

FIG. 1 is provided to illustrate a rack 60 that can be expanded into a basket form 50 as shown in following Figures (i.e. FIGS. 2 and 8). As the rack 60 or basket 50 is merely a possible accessory of the disclosed foldable bicycle and not to be contained in the scope of the present invention, it will not be discussed in great detail herein.

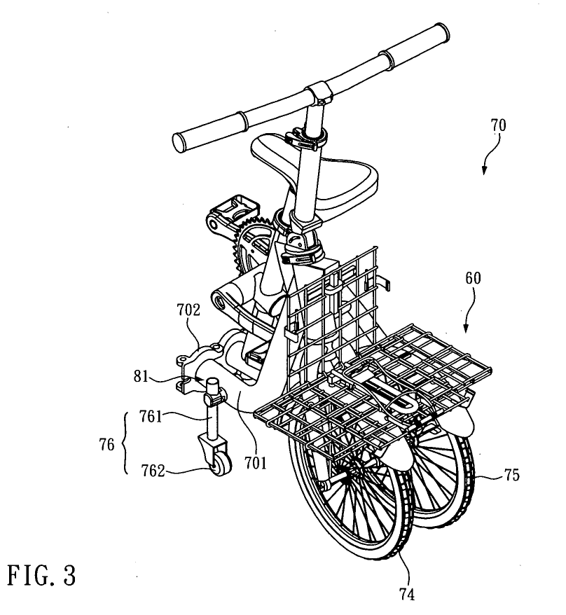

As shown in FIG. 2, a conventional foldable bicycle 70 comprises a folding segment 702 provided on the frame 701 thereof. Upon the folding segment 702, the front portion of the foldable bicycle can be folded toward the back portion thereof and a front wheel 74 and a back wheel 75 of the bicycle 70 can be settled abreast as shown in FIG. 3.

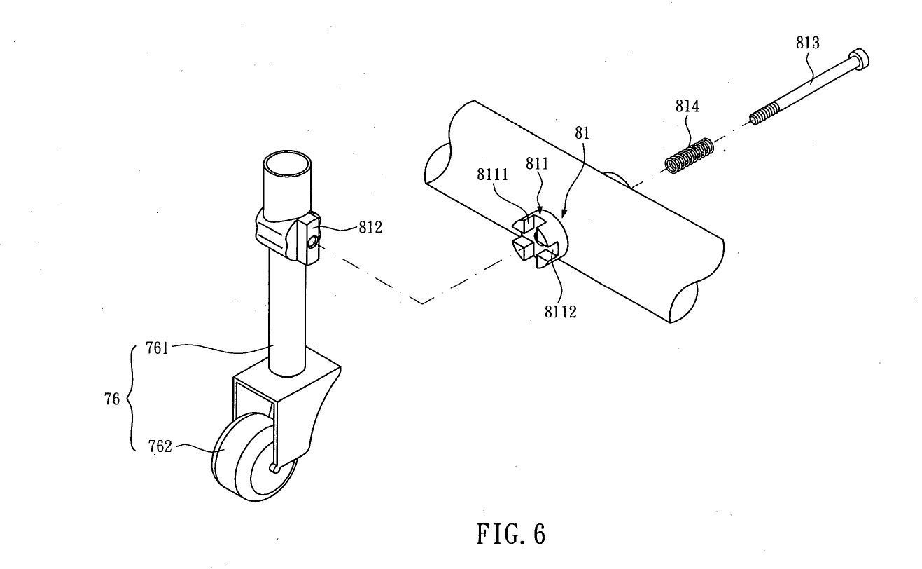

In FIGS. 2 and 3, it can be seen that an auxiliary wheel 76 is deposited on the frame 701 in front of the folding segment 702. The auxiliary wheel 76 may be situated at the left side, right side or bottom of the frame 701 and may be provided in the amount of one or more. The structure on the auxiliary wheel 76 can be referred to FIG. 6. It comprises a shaft 761 and a wheel 762 attached at the bottom of the shaft 761, wherein the position of wheel 762 can be adjusted with respect to the shaft 761 to ensure that the wheel 762 can be substantively-landed on the ground. The top of the shaft 761 is coupled to the frame 701 of the bicycle 70 by means of a pivot assembly 81. Said pivot assembly 81 comprises a cross-shaped recess 811 and a protruding bar 812 which are provided on the frame 701 and shaft 761 respectively wherein the both components are, fastened together by a fastening component 813 which is sheathed into an elastic component 814 and pivotally pierced therethrough. In virtue of the elastic component 814, the shaft 761 can be slightly pulled outward to allow the cross-shaped recess 811 and protruding bar 812 getting separated so that the shaft 761 can be pivoted on the fastening component 813. According to the present invention, when the protruding bar 812 is vertically engaged with the vertical groove 8111 of the cross-shaped recess 811, the shaft 761 is positioned perpendicularly and the wheel 762 is landed on the ground. Alternatively, when the protruding bar 812 is transversely engaged with the horizontal groove 8112 of the cross-shaped recess 811, the shaft 761 is positioned horizontally with respect to the frame 701 and the wheel 762 is departed from the ground.

When the disclosed bicycle 70 is folded, the user can set the auxiliary wheel 76 landed or retracted. When the auxiliary wheel 76 is landed, as shown in FIGS. 3, 4 and 5, the folded bicycle can work as a tri-wheel hand wagon or pull cart. Whereas, when the auxiliary wheel 76 is retracted, the folded bicycle can work as a dual-wheel hand wagon or pull cart, as shown in FIGS. 2, 7 and 8.

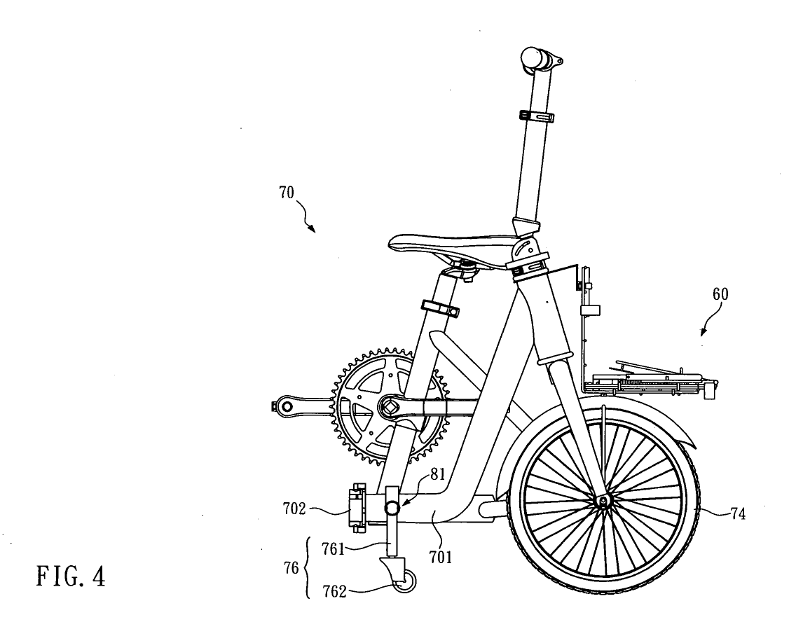

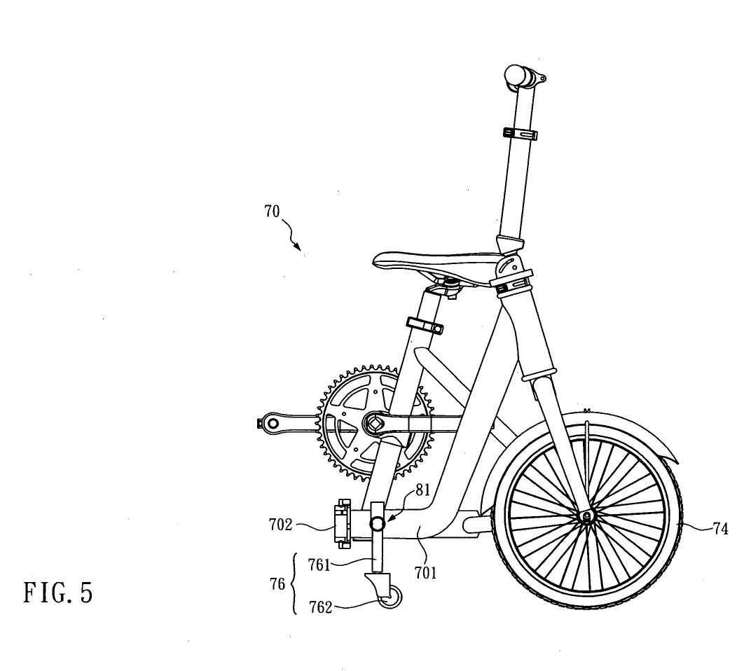

Additionally, in FIG. 4, the bicycle is now folded and with the auxiliary wheel 76 landed on the ground while the rack 60 is equipped thereto. FIG. 5 shows the bicycle alone, which, similar to FIG. 4, is folded and with the auxiliary wheel 76 landed on the ground.

Referring again to FIGS. 3, 4 and 5, when the bicycle is folded and with the auxiliary wheel 76 landed on the ground, the auxiliary wheel 76 can function in concert with the front and back wheels 74, 75 as three supporting points that are arranged in a triangular form on the ground and provide optimum support to a tri-wheel pull cart. Therefore, the folded bicycle supported by the landed auxiliary wheel 76 can possess a constant center of gravity and desirable balance ability whereby the folded bicycle can stand stably or move steady under an external push or pull force.

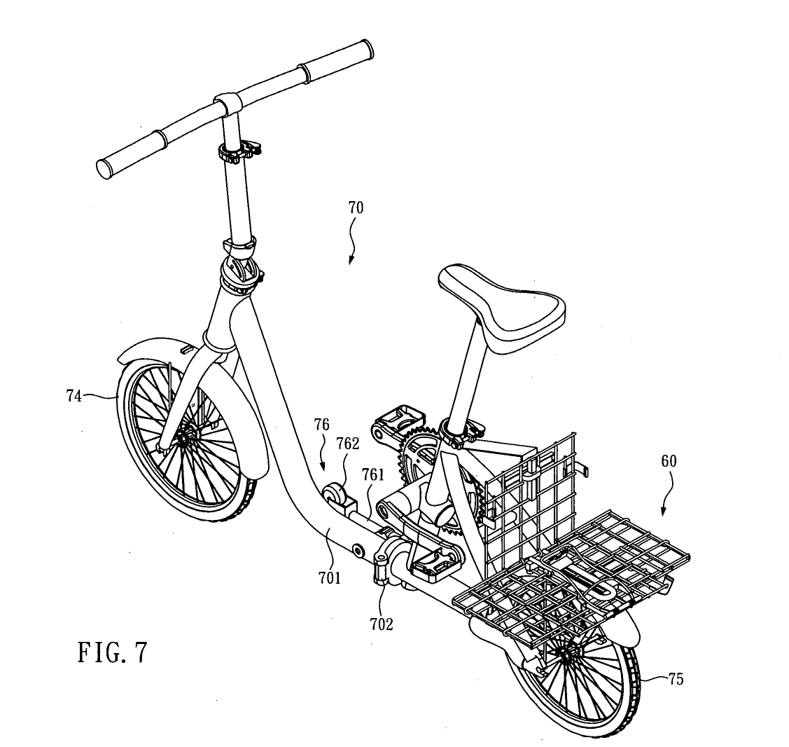

In FIGS. 2, 7 and 8, the bicycle is expanded for a user's riding. According to FIG. 2, said rack 60 is expanded into the form of the basket 50 and deposited in front of the head of the bicycle. In FIG. 7, the basket 50 is folded into the rack 60 and deposited at the tail of the bicycle over the back wheel 75. And in FIG. 8, it can be seen that the rack 60 is expanded into the form of the basket 50 and arranged at the tail of the bicycle over the back wheel 75.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A foldable bicycle that comprises a folding segment provided on the frame thereof, whereupon the bicycle can be folded in the manner that a front wheel is settled at the side of a back wheel of the bicycle and further comprises:
an auxiliary wheel deposited on the frame in front of the folding segment so that when the bicycle is folded, the auxiliary wheel, the front wheel and back wheel function as three supporting points that are arranged in a triangular form on a plane.

2. The foldable bicycle of claim 1, wherein the auxiliary wheel is deposited at the left side of the frame.

3. The foldable bicycle of claim 1, wherein the auxiliary wheel is deposited at the right side of the frame.

4. The foldable bicycle of claim 1, wherein the auxiliary wheel is deposited at the bottom of the frame.

5. The foldable bicycle of claim 1, wherein the auxiliary wheel comprises a shaft and a wheel attached at the bottom of the shaft wherein the top of the shaft is coupled to the frame of the bicycle by means of a pivot assembly.

6. The foldable bicycle of claim 5, wherein the pivot assembly comprises a cross-shaped recess and a protruding bar which are provided on the frame and the top of the shaft respectively, which are fastened together by a fastening component and an elastic component pivotally pierced therethrough.

7. The foldable bicycle of claim 5, wherein the position of wheel can be adjusted with respect to the shaft.
